(19) United States
(12) Patent Application Publication
(10) Pub. No.: US 2009/0020692 A1
(43) Pub. Date: Jan. 22, 2009

(54) SCATTERED RADIATION CORRECTION OF DETECTOR SIGNALS FOR PROJECTION-BASED IMAGING

(76) Inventors: Christoph Hoeschen, Hebertshausen (DE); Oleg Tischenko, Munchen (DE); Helmut Schlattl, Munchen (DE)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 12/162,806

(22) PCT Filed: Feb. 9, 2007
(86) PCT No.: PCT/EP2007/001124

§ 371 Date: Jul. 31, 2008

(30) Foreign Application Priority Data
Feb. 10, 2006 (EP) 06002754.7

(51) Int. Cl. G01D 18/00

(52) U.S. Cl. 250/252.1

(57) ABSTRACT

A method of correcting detector signals, in particular for scatter noise correction with an projection-based imaging device, comprises the steps of irradiating an object (1) with a radiation beam (2) including a plurality of discrete beam component (3, 3.1, 3.2) bounded by a plurality of masked angular ranges (4, 4.1, 4.2), so that the object (1) is partially irradiated with the beam components (3, 3.1, 3.2), detecting radiation transmitted through the object (1) with a detector device (30) comprising a plurality of detector portions (32, 32.1, 32.2, 33.1, 33.2), wherein direct radiation of the beam components (3) is detected by directly irradiated detector portions (32, 32.1, 32.2), detecting indirect radiation occurring in the masked angular ranges by masked detector portions (33.1, 33.2) adjacent to the directly irradiated detector portions (32, 32.1, 32.2), and correcting detector signals of the directly irradiated detector portions (32, 32.1, 32.2) in dependence on the detector signals of the masked detector portions (33.1, 33.2) for providing corrected detector signals. Furthermore, an imaging device for projection-based imaging is described.

### RELATED APPLICATIONS

This is a §371 of International Application No. PCT/EP2007/001124, with an international filing date of Feb. 9, 2007 (WO 2007/090667 A1, published Aug. 16, 2007), which is based on European Patent Application No. 06002754.7, filed Feb. 10, 2006.

### TECHNICAL FIELD

This disclosure relates to a method of correcting detector signals, in particular for projection-based imaging, e.g., correcting detector signals of an imaging device for projection radiography or for imaging tomography. Furthermore, the disclosure relates to a method and a device for imaging a region of investigation using the above method of correcting detector signals.

### BACKGROUND

The non-destructive investigation of objects is an important objective in various technical fields like material sciences, non-destructive testing, medical examinations, archaeology, construction technique, techniques concerning security matters etc. The classical approach for non-destructive investigation is based on an imaging of the object with projection radiography. The object is radiated with a radiation beam, e.g., an X-ray beam, which is attenuated due to an interaction with the object. Detecting the radiation beam transmitted through the object provides attenuation data on the basis of which an image of the object can be reconstructed. A more complex approach for obtaining an image of the object, e.g., by computer tomography (CT) is based on an irradiation through an object plane from different projection directions with X-rays, followed by the reconstruction of the object plane on the basis of attenuation data measured at different directions. The entirety of the measured attenuation data can be described in terms of so-called Radon data in a Radon space.

Different reconstruction methods for Radon data are known today, which in particular comprise iterative reconstruction methods and filtered back-projection methods. A further improved method of reconstructing image functions from Radon data is described in EP 04031043.5 (unpublished on the filing date of the present patent specification). With this method of using orthogonal polynomial expansions on the disk (in the following: OPED algorithm), an image function representing the region of investigation is determined from Radon data as a sum of polynomials multiplied with values of projection functions measured corresponding to a plurality of predetermined projection directions through the region of investigation.

The above projection-based imaging methods have a common disadvantage in terms of scattering noise generated by radiation scattering within the object. The generation of scattering noise, e.g., in medical X-ray imaging can be described as follows. The physical basis of an X-ray image is the absorption of photons emitted by an X-ray tube within the body under investigation. Since the organs (including bones) have different absorption properties, the number of photons passing through the body (primary photons) differs along each direction of the X-ray beam. The differing number of photons is detected with a detector device for providing the above attenuation data. However, photons are not only absorbed within the body, but are also scattered, mainly on electrons so that in particular secondary photons are generated. Depending on the size of the detector device, some of these scattered secondary photons will also be detected and recorded. Within the detector signals, the contributions of the secondary photons cannot be distinguished from the contributions of the primary photons. The secondary photons contain only very weak structural information so that the contributions thereof occur as the scattering noise only. As a result, the projection image reconstructed with attenuation data derived from the detector signals is deteriorated.

Initially, scattering noise was not a major concern in computer tomography as the detector sizes have been quite small and, thus, due to the small beam sizes only a few secondary photons were recorded. However, with increasing detector size, in particular with multi-slice CT devices, this problem becomes more prominent, all the more since circular CT devices with large flat panel detectors are planned.

A variety of strategies have been proposed for minimizing the scattering noise. A practical approach is based on providing an anti-scatter grid or an air gap between the object under investigation and the detector device for reducing the probability of secondary photons being recorded. However, secondary photons can be suppressed with this technique to a limited extend only. Secondary photons travelling along the beam path of the primary photons cannot be suppressed and the primary photons transmitted through the object are reduced as well. Accordingly, the radiation detection can be deteriorated by anti-scatter grids arranged in front of the detector device. Another conventional approach is based on theoretical models to determine the contribution of scattering noise in the signal (e.g., B. Ohnesorge et al. in “Eur. Radiol.,” vol. 9, 1999, p. 563-569). The theoretical models suffer from the limitation of reduced efficiency.

A direct method for X-ray scatter estimation and correction in computer tomography has been described by J. H. Siewerdsen et al. in “Med. Phys.” Vol. 33, 2006, p. 187-197. The object under investigation is irradiated with a cone-shaped X-ray beam bounded by collimator blades. The detector signal measured in regions behind the collimator blades is assumed to represent X-ray scatter within the object. The technique of J. H. Siewerdsen et al. has an essential disadvantage as the background signal obtained behind the collimator blades is used for correcting the detector signals corresponding to the whole field of view between the collimator blades. However, the object under investigation may include structures, which generate X-ray scatter within the field of view, which does not influence the background signal measured behind the collimator blades. This local X-ray scatter can not be corrected by the method of J. H. Siewerdsen et al. As a result, the conventional X-rays scatter correction may cause unintended artifacts in the reconstructed image.

A multiple beam computer tomography scanner adapted for irradiating an object under investigation with a plurality of discrete beams is described in U.S. Pat. No. 4,315,157. The discrete beams are formed with a mask arranged between an X-ray source and the object. According to the distribution of discrete X-ray beams, detectors are arranged behind the object. The detectors form detector groups, which are arranged with mutual distances on a stationary detector ring. The detector groups are aligned with mask openings and the focal point of the X-ray source. During scanning the object, the X-ray source and the mask are rotated with opposite rotating directions, so that the alignment is kept. The technique of U.S. Pat. No. 4,315,157 may have advantages in terms of sensitivity and local resolution. However, this technique requires two scans with and without the mask, respectively. As a result, the X-ray dose is increased. Furthermore, imaging artifacts may be caused by movements of the object. As a result, a solution of the above problems of scattering noise is not provided by this technique.

The above disadvantages are associated not only with the conventional CT imaging, but also with all available reconstruction methods based on radiation beam projection through the object under investigation.

It could therefore be helpful to provide an improved method of correcting detector signals avoiding the disadvantages of conventional projection-based object imaging. In particular, it could be helpful to overcome the restrictions in the conventional suppression or theoretical estimation of the secondary photons contributions in recorded projection images and to provide an improved quantitative evaluation of the scattering noise. It could further be helpful to provide an improved imaging device which allows recording of improved images based on projection imaging with reduced scattering noise.

### SUMMARY

Relating to the detector signal correction method, we provide a general technique of irradiating an object under investigation with a masked radiation beam and detecting direct radiation travelling along straight projection beam paths of a plurality of beam components of the radiation beam and indirect radiation leaving the beam paths of the beam components due to scattering in the object. Detector signals of a plurality of directly irradiated detector portions are corrected in dependence on detector signals of a plurality of adjacent detector portions recording indirect radiation only. The attenuation data to be obtained for projection-based imaging are derived from the corrected detector signals.

The beam components of the radiation beam are distributed within an angular range or field of view of the radiation beam. In contrast to the conventional strategies, an amount of scatter radiation in the immediate neighborhood of the at least one beam component is directly measured. Although this amount of scatter radiation is detected with at least one detector portion, which is not directly irradiated with the at least one beam component, an essentially improved correction of the directly transmitted beam component can be obtained. The scattering noise only weakly contains structural information, so that it is rather smoothly distributed. However, this distribution may cause imaging artifacts as mentioned above with reference to the conventional technique of J. H. Siewerdsen et al. Contrary to this conventional technique, we provide a locally resolved measurement of scatter radiation. We found that the detector signals of one or more masked detector portions adjacent to the directly irradiated detector portions can be used for quantitatively determining the scatter contribution in the directly irradiated detector portions. By this method, the desired corrected detector signals including contributions almost solely from primary photons can be restored to a high degree, so that the image quality can be strongly improved.

The partial irradiation of the object under investigation yields a reduced local resolution of the projection-based imaging. However, as a surprising result, we found that this drawback can be compensated for by current image reconstruction techniques, in particular, by the above OPED algorithm. The OPED algorithm provides an essentially improved local resolution compensating a possible resolution reduction due to the partial irradiation.

Relating to the device, we also provide a general technique of providing an imaging device for projection-based imaging of an object under investigation having a beam source for irradiating the object, a detector device for detecting direct radiation, travelling along the beam path of the a plurality of beam components and indirect radiation outside of the beam path, and a correction device being adapted for correcting detector signals of the directly irradiated detector portions in dependence on detector signals of the masked detector portions. The imaging device equipped with the correction device provides images with an essentially improved quality. Almost the complete scatter noise can be suppressed in the image of the object.

According to a preferred aspect, the discrete beam components for direct transmission through the object are formed by shaping the radiation beam emitted from a beam source. Preferably, the radiation beam is shaped with a beam mask having a plurality of mask through-holes, which mask is arranged between the beam source and the object under investigation. Accordingly, the imaging device can be provided with a beam mask for shaping the radiation beam of the beam source, wherein the beam mask is arranged in a distance between the beam source and the holding device. In contrast to conventional anti-scatter grids, the beam mask is positioned, relative to the travelling direction of the radiation beam, before the object. The radiation detection cannot be deteriorated as in the case of the conventional anti-scatter grids.

Advantageously, the beam mask provides a variability in shaping the radiation beam. The size and number of the through-holes transmitting the beam components can be selected in dependence on the particular projection-based imaging task and/or the reconstruction algorithm used. The number of through-holes of the mask is chosen such that a predetermined passing portion of the radiation beam forms the direct radiation passing thorough the mask, while the remaining blocked portion is suppressed. As an example, the passing portion and the blocked portion may comprise 9/10 and 1/10, respectively, in each dimension of the angular range of the radiation beam. As another example, which is preferred with the application of the OPED reconstruction algorithm, each of the passing and blocked portions may comprise ½ in each dimension of the whole angular range of the radiation beam.

According to a particularly preferred aspect, the beam mask is arranged at the beam source. The beam mask is preferably connected with the beam source. Accordingly, the beam mask can be moved with the beam source, if necessary. Furthermore, the size of the beam mask can be minimized. In contrast to the technique of U.S. Pat. No. 4,315,157, a complex movement of beam mask contrary to the scanning direction is avoided.

As a further advantage, the detector signals from the directly irradiated detector portions and the mask detector portions can be simultaneously collected. Direct radiation (including structural information) and scatter radiation can be collected with one single scan (rotation of the X-ray source with the beam mask) only. Advantageously, the X-ray dose is correspondingly reduced.

Generally, the detector signal correction can be provided with single beam components each bounded by one or more masked (or shielded) angular ranges in which the radiation beam is blocked. The radiation beam is shaped with a plurality of discrete beam components. Accordingly, the beam mask comprises a plurality of mask through-holes for shaping the radiation beam with the plurality of beam components. In this case, the radiation beam is divided by the beam mask into a bunch of beam components passing the object or at least a region of investigation within the object. For each of the beam components, indirect radiation is detected with a plurality of detector portions adjacent to the directly irradiated detector portions of the related beam component. With a plurality of discrete beam components, the efficiency of image recording is essentially increased.

Advantageously, the detector signal correction can be combined with available image reconstruction techniques. Attenuation data derived from the corrected detector signals can be subjected to an iterative image reconstruction or the filtered back-projection algorithm. If the corrected detector signals are provided for an image reconstruction based on the above OPED algorithm, further advantages are obtained. With the OPED algorithm, attenuation values of a discrete set of beam components are processed. Advantageously, the masked radiation beam used is even adapted to this discrete geometry used for the OPED algorithm. According to a particular preferred aspect, the discrete beam components are formed with the beam mask with a uniform angular distribution, which represents the best adaptation of the irradiation geometry to the requirements of the OPED algorithm.

The detector signal correction can be simplified if a background (scatter) signal derived from the shielded detector portions is subtracted from the detector signals of the directly irradiated detector portions. Advantageously, the scatter noise contribution can be compensated by a simple mathematical operation, which preferably is performed by a subtraction unit included in the correction device for calculating the corrected detector signals.

Preferably, the background signal is obtained by an interpolation between the detector signals obtained from masked detector portions on opposite sides of the directly irradiated detector portion. Alternatively, the background signal is obtained as an average signal of one masked detector portion only being arranged adjacent to the respective directly irradiated detector portion.

Various conventional interpolation algorithms are available for calculating the background signals. As the detector signals of the masked detector portions are smoothly distributed, a linear interpolation between the averaged detector signals of the masked detector portions can be used according to a preferred aspect. Alternatively, other interpolation algorithms can be implemented, e.g., a cubic interpolation.

For a simple non-destructive investigation of the object, the recording of one single projection of the energy beam component can be sufficient. However, according to a preferred aspect, the steps of irradiating the object with the at least one discrete beam component and detecting the direct and indirect radiation contributions are repeated with a plurality of different orientations of the at least one discrete beam component relative to the object. Particularly preferred is a rotation of the beam source with the beam mask around the object. Advantageously, a complete image of the object can be reconstructed on the basis of the corrected detector signals obtained with the different irradiation orientations.

Another advantage is related to the fact that there is no restriction to a particular projection-based imaging method. The detector signal correction can be used for any conventional projection radiography, like conventional X-ray imaging or neutron radiation imaging. According to a preferred implementation, the irradiating and detecting steps for recording the direct and indirect detector signals are performed with a computer tomography device (CT device). Advantageously, the structure of a CT device is adapted to the irradiation and detection geometry used.

According to a further preferred aspect, the detector device comprises a plurality of detector elements (pixels) arranged directly adjacent to each other. Advantageously, the detector elements can be assigned to the directly irradiated or masked detector portions, respectively. This assignment can be provided in dependence on an amount of radiation detected. Detector elements with low signal are assigned to the masked detector portions, while detector elements with increased signal (e.g., compared with a predetermined threshold value) are assigned to the directly irradiated detector portions. Preferably, weighting of background signals from the masked detector portions is provided, depending on the number of detector elements belonging to a certain masked detector portion.

According to a further preferred aspect, the number of detector elements of the detector device is chosen according to the parameters (number and size of through-holes) used for the mask. Preferably, the detector device comprises a panel detector with integrated detector elements.

Relating to method features, an independent subject is an imaging method, in particular for projection-based imaging, wherein an image of the object is reconstructed on the basis of detector signals corrected with the above correction method. The image reconstruction is conducted with at least one of the iterative algorithm, the filtered back-projection algorithm or the OPED algorithm. The application of the OPED algorithm is particularly preferred as the OPED algorithm provides an improved local resolution. Details and terms of the OPED algorithm are described in EP 040 310 43.5, which is incorporated herein by reference.

### BRIEF DESCRIPTION OF THE DRAWINGS

Further details and advantages are described in the following with reference to the attached drawings, which show in:

FIG. 1 a schematic illustration of an operation principle of an imaging device;

FIG. 2 a flow chart illustrating an embodiment of the correction method;

FIG. 3 details of a preferred embodiment of an imaging device;

FIG. 4 schematic illustrations of beam masks;

FIG. 5 a schematic illustration of a further embodiment of an imaging device; and

FIG. 6 images illustrating the advantages of our methods.

### DETAILED DESCRIPTION

Our apparatus and methods are described below with reference to our preferred application in computer tomography. It is emphasized that our apparatus and methods can be implemented in an analogous way with the application of other types of energy input beams (e.g., neutrons or light, e.g., in the VIS or IR range) and/or other types of projection-based imaging (e.g., projection radiography). Furthermore, the following description of the preferred aspects mainly refers to the data collection and data processing. Details of the CT devices are not described since they are known from conventional CT devices.

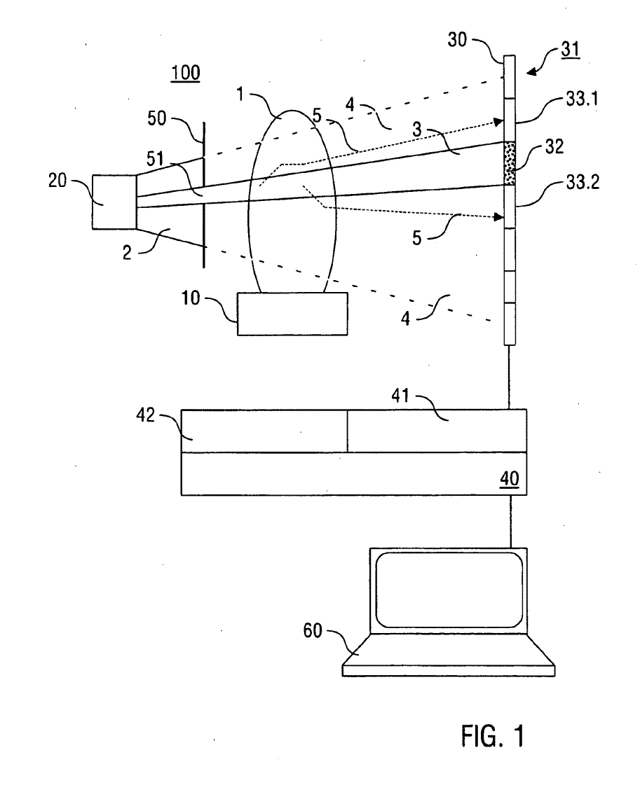

An operation principle of the imaging device 100 is illustrated in FIG. 1. The imaging device 100 comprises a holding device 10, a beam source 20, a detector device 30, a correction device 40, a beam mask 50 and a control device 60. For clarity reasons, the illustration shows an irradiation of the object 1 under investigation with a single discrete beam component 3 only. With the practical implementation, a plurality of distributed discrete beam components 3 is formed.

The holding device 10 is a carrier for supporting or hanging the object 1 in the radiation field of the beam source 20. As an example, the holding device 10 comprises a carrier table as it is known from CT devices. The beam source 20 comprises, e.g., an X-ray tube emitting a fan or cone beam of X-rays as it is know from conventional X-ray tubes.

The beam mask 50 comprises a plane plate model of a shielding material, e.g., tungsten or lead. The beam mask 50 includes a plurality of through-holes (only one through-hole 51 is shown), which can be passed by a part of the radiation beam emitted from the energy beam source. 20. In the illustration, the radiation beam 2 emitted by the beam source 20 is shielded with the beam mask 50 so that discrete beam components (e.g., beam component 3) are directed through the object 1 to the detector device 30, while the adjacent angular ranges 4 are masked.

The detector device 30 comprises a flat panel detector including a plurality of detector elements (pixel) 31. The detector device 30 comprises, e.g., a straight arrangement of the detector elements 31 each of which having a width in the range of about 0.1 mm to 1 mm. Advantageously, the method does not set any constrains on the size of each detector element 31.

The detector elements 31 of the detector device 30 can be assigned to different detector portions, depending on the radiation detected. The detector elements directly irradiated along the straight beam path of the discrete beam component 3 are assigned to the irradiated detector portion 32, while the detector elements in the immediate neighborhood of detector portions 32 are assigned to masked detector portions 33.1, 33.2.

The size ratio of the irradiated detector portion 32 and the masked detector portions 33.1, 33.2 can be adjusted and optimised in dependence on the demands of the respective imaging process. In particular, each of the masked detector portions 33.1, 33.2 adjacent to the directly irradiated detector portion 32 may comprise one single detector element only or a plurality of detector elements. Depending on the number of detector elements of a masked detector portion, the interpolation is to be weighted. Due to scattering within the object 1, scatter radiation 5 is travelling along irregular directions to the masked detector portions 33.1, 33.2.

The correction device 40 comprises an interpolation unit 41 and a subtraction unit 42 for calculating corrected detector signals. Furthermore, the correction device 40 can comprise further circuit components, in particular for assigning detector elements 31 to directly irradiated or masked detector portions.

The control device 60 is adapted for controlling the correction device 40, the energy beam source 20, the read-out of the detector device 30 and possibly the relative arrangement of the holding device 10 and the energy beam source 20. Both the correction device 40 and the control device 60 can be implemented with a common electronic circuit, like a computer unit. Furthermore, the control device 60 can comprise a display for monitoring the operation of the imaging device 100 and the results of the imaging.

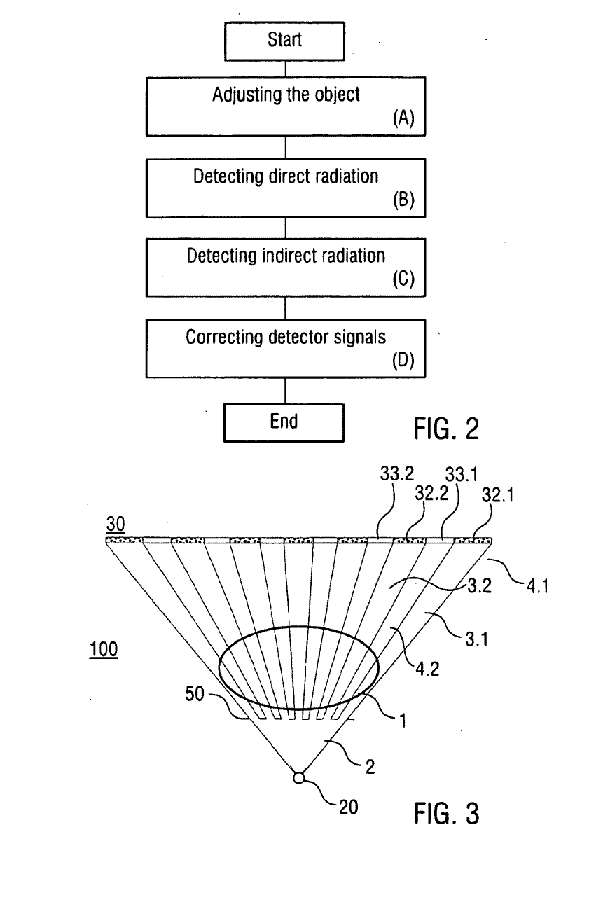

The detector signal correction method comprises the procedural steps summarized in FIG. 2. Firstly, the object 1 and the beam source 20 are adjusted relative to each other (step A). Step A includes the assignment of detector elements to one of the detector portions 32 or 33.1, 33.2. This assignment can be obtained by a comparison of the detector signal of each detector element with a threshold value. All detector elements with a detector signal above the threshold value are assigned to the directly irradiated detector portion 32, while the remaining detector elements are assigned to the masked detector portions 33.1, 33.2.

Subsequently, the beam source 20 is operated for an irradiation of the object 1 through the mask 50. With the irradiation, the direct radiation of the discrete beam components (step B) and the indirect radiation scattered in the object 1 (step B) are simultaneously detected with the detector portions 32 and 33.1, 33.2, respectively.

According to the number of detector elements assigned to the directly irradiated detector portion 32, a plurality of detector signals are recorded. Each masked detector portion 33.1, 33.2 can comprise a plurality of detector elements as well. For providing one characteristic detector signal for each of the masked detector portions 33.1, 33.2, the individual detector signals of the detector elements assigned to the masked detector portions 33.1, 33.2 are averaged.

Finally, corrected detector signals are calculated (step D). Firstly, a background signal is obtained by a linear interpolation between the characteristic (average) detector signals obtained with the masked detector portions 33.1, 33.2. Depending on the number of detector elements, which belong to the masked detector portions 33.1, 33.2, the characteristic detector signals and/or the interpolation is weighted. The background signal is subtracted from each of the detector signals of the detector elements 31 in the directly irradiated detector portion 32. Finally, attenuation data corresponding to the corrected detector signals are provided for image processing. If, according to an alternative aspect, only one masked detector portion is used for recording scatter noise, the background signal is directly obtained from the characteristic (average) detector signal obtained with the masked detector portion.

FIG. 3 illustrates details of a preferred structure of the imaging device 100. Imaging device 100 includes the beam source 20, the beam mask 50 and the detector device 30. The beam source 20 is adapted for emitting an X-ray fan beam 2, which is shaped with the beam mask 50 into a plurality of discrete beam components 3.1, 3.2, . . . . Each of the discrete beam components, 3.1, 3.2, . . . is bounded by masked angular ranges 4.1, 4.2, . . . wherein the radiation beam 2 is shielded. Accordingly, the detector elements of detector device 30 can be assigned to directly irradiated detector portions 32.1, 32.2, . . . separated by masked detector portions 33.1, 33.2, . . . . Only the detector elements of the directly irradiated detector portions 32.1, 32.2, . . . detect the projection image of the object 1 including primary and secondary photons. The remaining elements (masked detector portions 33.1, 33.2 . . . ) are used to determine the contribution of the secondary photons only.

For correcting the signals of a particular directly irradiated detector portion (e.g., 32.2), the related background signal is calculated by interpolation of the average detector signals of the immediately adjacent masked detector portions (e.g., 33.1, 33.2). The average detector signal of one of the masked detector portions (e.g., 33.1) is used for calculating the background signals corresponding to the immediately adjacent directly irradiated detector portions (e.g., 32.1, 32.2).

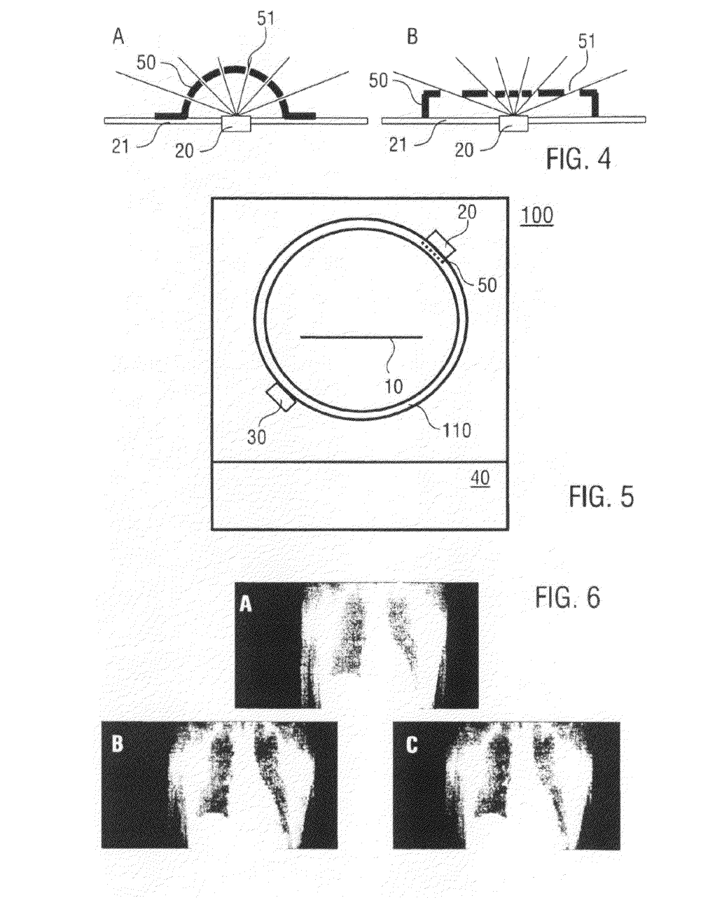

Examples of the beam mask 50 in combination with the beam source 20 are schematically illustrated in FIG. 4. The beam mask 50 can have a spherical shape (FIG. 4A) or a plane shape (FIG. 4B) or any other appropriate shape adapted to the geometric conditions of the imaging device. Each beam mask 50 comprises a plurality of through-holes 51, preferably arranged with an equal arc length spacing. The beam mask 50 is fixed to the beam source 20, in particular to a frame 21 of the beam source 20, preferably by a detachable fixing element, e.g., a clip element or a snap connection. The beam mask 50 comprises, e.g., 200 through-holes 51 for providing 200 discrete beam components.

Generally, the size, shape and through-hole number of a mask can be adapted to the particular irradiation geometry used in an imaging device. The shape of the through-holes can be adapted to the orientation of the detector device 30 relative to the beam source 20. As an example, slit shaped through-holes 51 can be provided.

FIG. 5 illustrates a further structure of an imaging device 100, which is structured like a conventional CT device with the holding device 10, the beam source 20, the detector device 30 and the correction device 40. The beam source 20 with the beam mask 50 is rotatable with the detector device 30 around an object on the holding device 10. Both components 20, 30 can be rotated in the CT gantry 110 as it is known from conventional CT devices.

FIG. 6 illustrates simulation results showing the capabilities of the method. A Monte Carlo code has been used to simulate a thorax X-ray image with the beam mask in front of the beam source. The image of FIG. 6A is reconstructed from Radon data recorded in the directly irradiated detector portions including both primary and secondary photons (conventional image). FIG. 6B illustrates the image which would result if only primary photons would be recorded, while FIG. 6C illustrates the results when subtracting the scatter data recorded by the masked detector portions from the signal of the detector elements in the directly irradiated detector portions. As a result, a good agreement of the desired scatter-free image FIG. 6B) is obtained (FIG. 6C) which is considerably improved compared with the conventional image (FIG. 6A).

The features disclosed in the above description, the drawings and the claims can be of significance both individually as well as in combination for the realization of our apparatus and methods in their various forms and manifestations.

1. A method of correcting detector signals comprising
irradiating an object under investigation with a radiation beam including a plurality of discrete beam components bounded by a plurality of masked angular ranges so that the object is at least partially irradiated with the beam components;
detecting radiation transmitted through the object with a detector comprising a plurality of detector portions, wherein direct radiation of the beam components is detected by a plurality of directly irradiated detector portions;
detecting indirect radiation occurring in the masked angular ranges by a plurality of masked detector portions adjacent to the irradiated detector portions; and
correcting detector signals of the directly irradiated detector portions in dependence on detector signals of the adjacent masked detector portions to provide corrected detector signals.

2. The method according to claim 1, wherein the radiation beam is shaped with a beam mask arranged between a beam source and the object.

3. The method according to claim 2, wherein the radiation beam is shaped with a beam mask arranged at the beam source.

4. The method according to claim 1, wherein the discrete beam components are formed with a uniform angular distribution.

5. The method according to claim 1, wherein each of the discrete beam components is bounded by at least two masked angular ranges arranged on opposite sides of the respective discrete beam component.

6. The method according to claim 1, wherein the corrected detector signals are calculated by subtracting a background signal from the detector signals of the directly irradiated detector portions, the background signal being derived from the detector signals of the masked detector portions.

7. The method according to claim 6, wherein the background signal is calculated by an interpolation between the detector signals of the at least two masked detector portions.

8. The method according to claim 1, wherein each of the at least one discrete beam components is bounded by one single masked angular range and the background signal is substantially equal to the detector signal of the masked detector portion.

9. The method according to claim 1, wherein the steps of irradiating the object and detecting radiation transmitted through the object are repeated for a plurality of different orientations of the at least one discrete beam component relative to the object.

10. The method according to claim 1, wherein irradiating and detecting are performed with a computer tomography device.

11. The method according to claim 1, wherein the detector includes a plurality of detector elements, and the method further comprises
assigning the detector elements to directly radiated or masked detector portions, respectively, depending on the radiation detected.

12. The method according to claim 11, further comprising
weighting background signals from the masked detector portions depending on the number of detector elements of the masked detector portions.

13. An imaging method, comprising:
collecting corrected detector signals with the method according to claim 1; and
reconstructing an image of the object.

14. The imaging method according to claim 13, wherein reconstructing comprises application of at least one of:
an iterative reconstruction algorithm;
a filtered back-projection algorithm; and
a reconstruction algorithm based on orthogonal polynomials.

15. An imaging device that images an object under investigation comprising:
a beam source for irradiating the object with a radiation beam including a plurality of discrete beam components bounded by a plurality of masked angular ranges so that the object is at least partially irradiated with the beam components (3); and
a detector comprising a plurality of detector portions that detect radiation transmitted through the object, wherein the detector portions include a plurality of directly irradiated detector portions that detect direct radiation of the beam components and masked detector portions adjacent to the plurality of irradiated detector portions and arranged to detect indirect radiation occurring in the masked angular ranges: and
the detector is connected with a correction device that provides corrected detector signals by correcting detector signals of the directly irradiated detector portions in dependence on detector signals of the masked detector portions.

16. The imaging device according to claim 15, further comprising a holding device for accommodating the object.

17. The imaging device according to claim 16, further comprising a beam mask that shapes the radiation beam, wherein the beam mask is arranged between the beam source and the holding device.

18. The imaging device according to claim 17, wherein the beam mask is connected to the beam source.

19. The imaging device according to claim 17, wherein the beam mask comprises a plurality of mask through-holes for shaping the radiation beam with the plurality of the discrete beam components bounded by the plurality of the masked angular ranges.

20. The imaging device according to claim 19, wherein the mask through-holes form the discrete beam components with a uniform angular distribution.

21. The imaging device according to claim 15, wherein the correction device includes a subtraction unit that calculates the corrected detector signals by subtracting a background signal from the detector signals of the irradiated detector portions, the background signal being derived from the detector signals of the masked detector portions.

22. The imaging device according to claim 15, wherein the detector portions include at least two masked detector portions adjacently arranged on opposite sides of the irradiated detector portions.

23. The imaging device according to claim 22, wherein the correction device includes an interpolation unit that calculates the background signal by an interpolation between the detector signals of the at least two masked detector portions.

24. The imaging device according to claim 15, wherein the beam source is movable relative to the holding device.

25. The imaging device according to claim 15, wherein the holding device, the beam source and the detector comprise a computer tomography device.

26. The imaging device according to claim 15, wherein the detector comprises a plurality of detector elements arranged to be assigned to the irradiated or masked detector portions, respectively.

27. The imaging device according to claim 15, wherein the detector comprises a panel detector with integrated detector elements.
